(19) United States
(12) Patent Application Publication
(10) Pub. No.: US 2004/0173644 A1
(43) Pub. Date: Sep. 9, 2004

(54) Fitment assembly for containers

(76) Inventors: Christopher Ramsey, Oxfordshire (GB); Roger Geoffrey Tanner, Essex (GB); Bernard Guglielmini, Crimolois (FR)

Correspondence Address: Vincent L Ramik, Diller Ramik & Wight, Suite 101, 7345 McWhorter Place, Annandale, VA, 22003, US

(21) Appl. No.: 10/311,020

(22) PCT Filed: Jun. 15, 2001
(86) PCT No.: PCT/GB01/02623

(30) Foreign Application Priority Data
Jun. 15, 2000 (EP) 00305083.8

(51) Int. Cl. B67D 3/00

(52) U.S. Cl. 222/519

(57) ABSTRACT

A fitment is described for use with a container such as a paperboard carton, having an operable section such as a removable disc surrounded by a pre-scored track. The fitment comprises a housing (3) secured to the container surrounding the removable disc (14). A central section (10) is attached to the disc (14), and to the housing (3) by means of arms (18) such that it can adopt either one of two bistable positions. Unscrewing of a closure (4) causes the central section (10) to flip from one of its bistable positions to the other, pushing the removable disc in to the carton to provide an opening therein. The disc (14) remains attached to the central section (10), laterally displaced from its original position, to act as a flow regulator to prevent ‘glugging’ when liquid product exits the carton.

This invention relates to fitments for containers such as paperboard cartons, such cartons being very commonly used as containers for milk or fruit juices etc.

Paperboard cartons have begun to be sold with plastics closures, avoiding the need to unfold or cut the carton. Such closures sometimes operate around a pre-cut opening, which has been resealed by a peelable foil. One type of carton system has a fitment surrounding a cut out hole in the carton. The hole is closed by a membrane on the fitment, which can be removed using a plastics ring pull element. Other types of closure can, on opening, cut through a foil to gain access to the inside of the carton, or alternatively push out a pre-scored section of carton.

This invention relates to the type of fitment which can cooperate with an operable section such as a piercable foil or an area of the container surrounded by a pre-scored track. Such operable sections can either be pulled away from the remainder of the carton (as with our copending application ref. W0184 filed the same day as this application), or pushed into the carton. Where the operable section is pushed into the carton there is a risk that it will continue to interfere with the flow of product from the container, e.g by forming a flap which can partially or completely obstruct the opening under the action of the flow of product. It is an object of the present invention to provide a fitment for a container which does not suffer from the above disadvantage.

Accordingly, there is provided a fitment for use with a container having an operable section adapted to be activated to allow access to the contents of the container, the fitment comprising;

i) a plastics housing adapted to be secured to the container surrounding the operable section; and

ii) a panel portion adapted to be secured to the operable section of the container, the panel portion being attached to the housing such that it is movable between first and second bistable positions, the panel portion being operable by the user to cause it to move from its first position to its second position, this movement causing the operable section of the container to be separated from the remainder of the container so as to provide an exit for the contents of the container, in its second position the panel portion remaining attached to the housing.

In their second position, the panel portion and operable section of the container are held at a distance from their original position, preferably substantially parallel thereto, in order to provide an opening for the product to exit the container. It has surprisingly been found that not only does this prevent the operable portion from interfering with the ingress of product from the container, it can actually improve the flow thereof. Liquid products are prone to “glugging” as they are dispensed from containers, due to the competition caused by air needing to enter the container through the aperture whilst the liquid is being dispensed therefrom. The panel portion and operable section, held at a predetermined distance from their original position, act as a flow regulator to allow product to exit the container with substantially less “glugging”.

The bistability of the central section allows the panel portion with the operable section attached to remain attached to the housing in the second position and still allow pouring, with the additional benefit of improved pouring. In a normal closure fluid flows through a spout which may also be the cutting element. If the cutting element in such a closure is to remain attached to the operable section there is no fluid path through the cutting element. By holding the panel portion and operable section away from the exit using bistability, fluid can be poured around the edge of the panel portion and the operable section. In addition, with this arrangement the panel portion can be moulded in one piece with the housing

The fitment preferably includes an additional component, the movement of which causes the panel portion to move from its first position to its second position. The additional component is conveniently rotatable with respect to the housing, this rotation causing the movement of the panel portion. The fitment is preferably provided with a closure adapted to seal the plastics housing, and this closure conveniently comprises the additional component, rotation of which causes the movement of the panel portion. The closure preferably includes a downwardly extending threaded member and the panel portion includes a complementary upwardly extending threaded member, the two threaded members corresponding such that rotation of the closure is translated into a corresponding natural movement of the panel portion. The downwardly extending member on the closure conveniently comprises a cylinder having a thread on the internal surface thereof, and the upwardly extending member on the panel portion conveniently comprises a piston having an external thread thereon. In this way, rotation of the closure is translated into a corresponding downward movement of the panel portion, through the action of the threaded piston and cylinder arrangement.

The panel portion is preferably attached to the housing by a plurality of arms, each arm being disposed at an angle to the plane of the panel portion. The first bistable position of the panel portion is conveniently when the arms are disposed at a certain angle to the plane of the panel portion on one side thereof, and the second bistable position is conveniently when the arms are disposed at the same certain angle to the plane of the panel portion but on the opposite side thereof. Downward movement of the panel portion therefore causes the arms to “flip” from their upward inclination to their downward inclination, causing an almost instantaneous separation of the operable section from the remainder of the container. Typically three arms are provided equidistantly spaced around the panel portion, and the plastics housing and the panel portion are conveniently integrally moulded in one piece.

The closure is conveniently provided with a tamper-evident band attached thereto and adapted to be frangibly detached from the closure on opening of the container. The tamper-evident band is conveniently designed to become frangibly detached from the closure immediately following the movement of the panel portion from its first position to its second position. Typically, rotation of the closure in a direction designed to unscrew it from the container first causes the panel portion to be moved downwardly to its second bistable position. This causes the tamper-evident band to break, and further rotation of the closure in the same direction results in the closure being removed from the fitment to allow access to the contents of the container.

Conveniently the panel portion is substantially in the form of a cone, with the base of the cone being fixed to the operable section of the container. Alternatively or additionally, the panel portion comprises a central section surrounded by a plurality of legs extending therefrom. Each leg is typically disposed such that the distal end thereof is adjacent the edge of the operable section of the container. This arrangement facilitates the efficient severing of the operable section, as the panel portion moves from its first position to its second position. Typically three legs are provided equidistantly spaced around the central section.

The plastics housing typically includes a substantially planar annular portion adapted to be affixed to the container. The planar annular portion conveniently has a downwardly depending flange on the inner radial extent thereof. Where the housing is affixed to the container using an adhesive applied to the annular portion, the downwardly depending flange prevents the adhesive flowing therebeyond, minimising the possibility that adhesive will flow onto the operable section.

In a prefered embodiment a fitment is provided for use with a paperboard carton having an operable section in the form of a removable disc surrounded by a pre-scored track. The fitment comprises a housing secured to the container surrounding the removable disc. A central section is attached to the disc, and to the housing by means of arms such that it can adopt either one of two bistable positions. Unscrewing of a closure causes the central section to flip from one of its bistable positions to the other, pushing the removable disc into the carton to provide an opening therein. The disc remains attached to the central section, laterally displaced from its original position, to act as a flow regulator to prevent ‘glugging’ when liquid product exits the carton.

The invention further resides in the combination of a container and a plastics fitment, the container having an operable section adapted to be activated to allow access to the contents of the container, the fitment comprising

i) a plastics housing secured to the container surrounding the operable section; and

ii) a panel portion attached to the operable section of the container, the panel portion being attached to the housing such that it is movable between first and second bistable positions, the panel portion being operable by the user to cause it to move from its first position to its second position, this movement causing the operable section of the container to be separated from the remainder of the container so as to provide an exit through which the contents of the container may be dispensed, in its second position the panel portion remaining attached to the housing and the operable section remaining attached to the panel portion.

The invention will now be further described, by way of example only, with reference to the accompanying drawings, in which like reference numerals refer to like parts and in which:

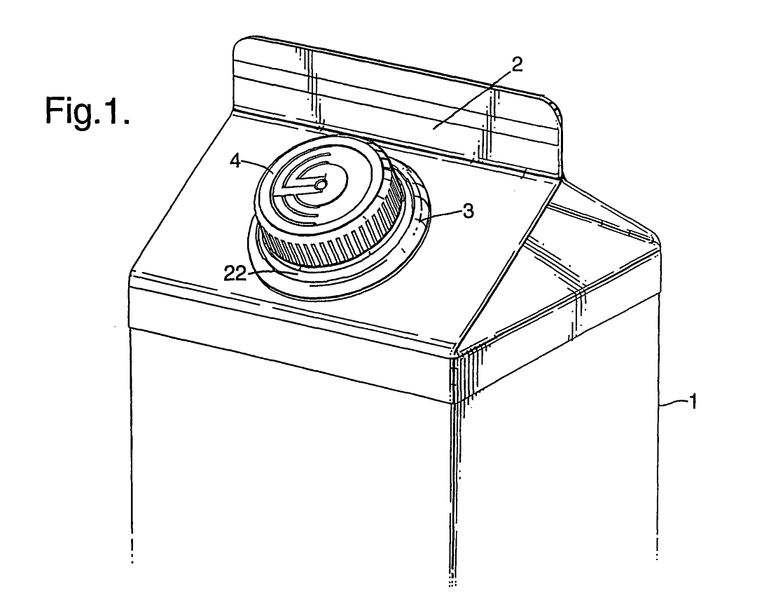

FIG. 1 is a schematic perspective view of part of a paperboard carton including a fitment according to the present invention;

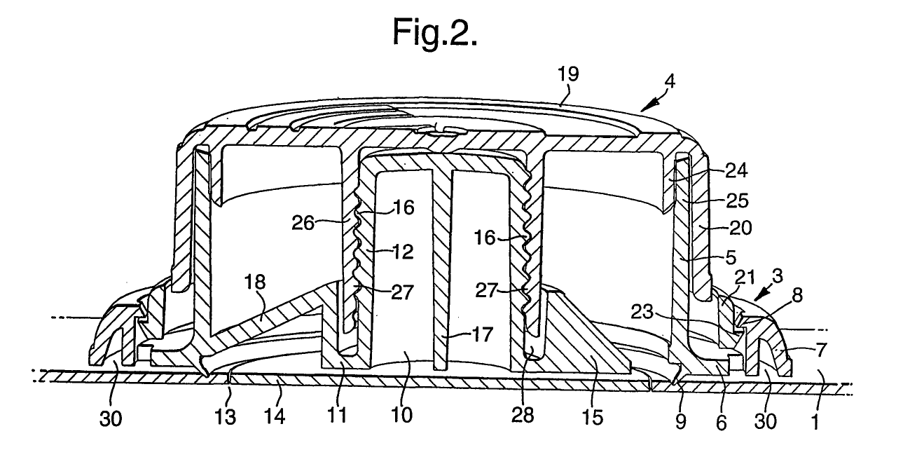

FIG. 2 is a schematic cross sectional view of the fitment of FIG. 1, shown in its “closed” position;

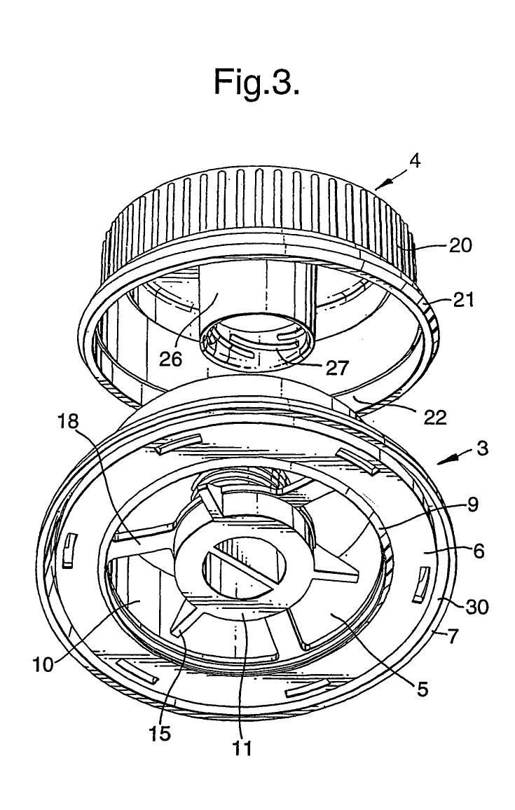

FIG. 3 is an exploded view of the fitment of FIG. 2, shown from underneath;

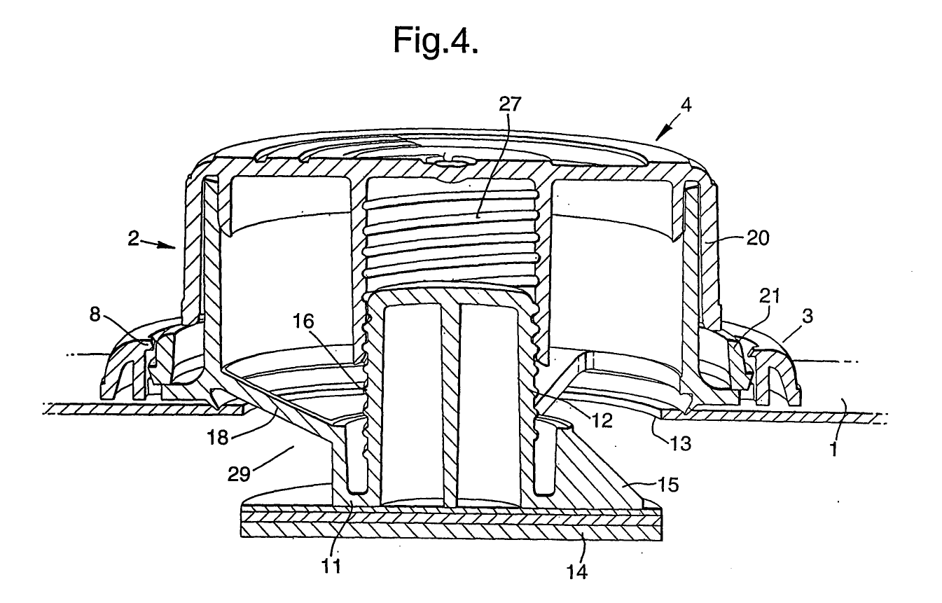

FIG. 4 is a schematic cross sectional view of the fitment of FIG. 1 shown in a partially open position;

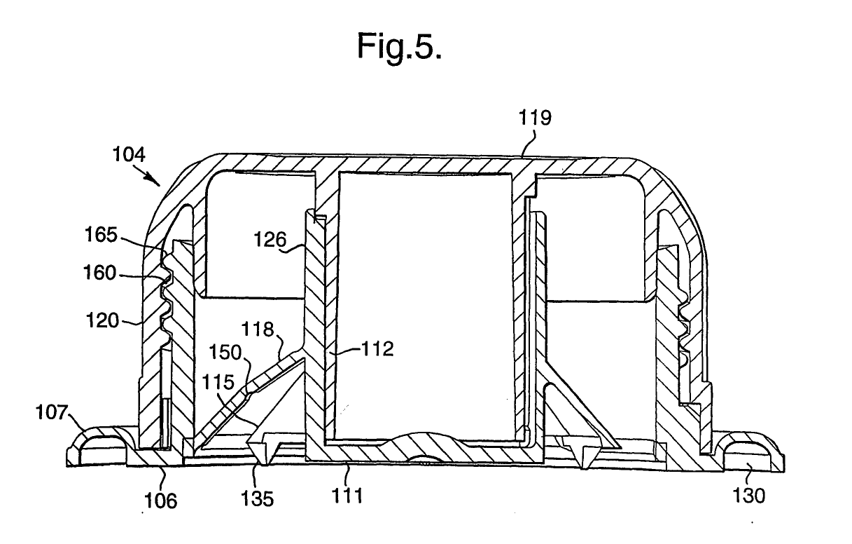

FIG. 5 is a schematic cross sectional view of a fitment according to an alternative embodiment;

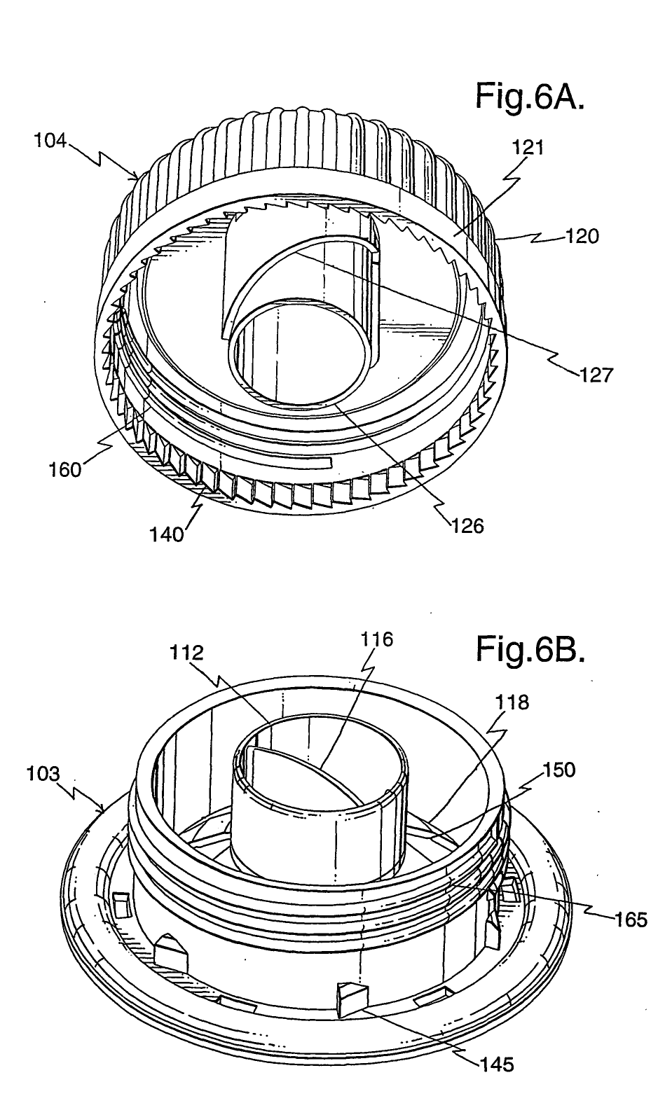

FIG. 6A is a schematic perspective view of the closure of the fitment shown in FIG. 5; and

FIG. 6B is a schematic perspective view of the housing of the fitment shown in FIG. 5.

Referring to FIG. 1, a laminated paperboard carton shown generally at 1 is provided with a fitment shown generally at 2. The fitment comprises a housing 3 and a closure 4.

Referring to FIGS. 2 and 3, the housing 3 includes an upstanding cylindrical sidewall 5 and a peripheral flange 6. The flange is attached to the carton 1 by means of an adhesive (not shown). The flange 6 is annular, and is provided on its outer periphery with a raised formation 7 which includes a plurality of inwardly extending catch elements 8. The raised formation 7 defines an annular channel 30 which serves to accommodate excess adhesive and to increase the surface area of the flange 6 which is exposed to the adhesive, thereby increasing the adhesion of the housing 3 to the carton 1. The inner periphery of the flange 6 is provided with a downwardly extending annular lip 91 which is designed to constrain the adhesive and prevent it flowing inwardly of the flange 6.

The housing 3 also includes a central section 10 comprising a base 11 and a hollow piston 12 extending upwardly therefrom. The carton 1 is provided with a pre-scored track 13 defining a removable panel 14 therein. The base 11 and/or central strut 17 are secured, again by means of an adhesive (not shown), to the removable panel 14. The base 11 is provided with three triangular leg portions 15, extending outwardly from the base and terminating adjacent the pre-scored track 13. The piston 12 is provided with thread formations 16 on the exterior surface thereof, and is strengthened by a central strut 17.

The central section 10 is attached to the sidewall 5 of the housing by means of three flexible arms 18, which extend from the bottom of the sidewall 5 to the top of the base 11. In the “closed” position shown in FIGS. 2 and 3, the arms 18 extend upwardly at an angle of approximately 30° to the plane of the carton 1 and removable panel 14.

The closure 4 comprises a top panel 19 and an outer skirt 20 depending downwardly at the periphery thereof. An annular tamper-evident band 21 is attached to the bottom of the outer skirt 20 by means of frangible bridges 22. The tamper-evident band 21 has a ledge 23 which is received under the catch elements 8 on the housing 3, preventing its removal therefrom. The closure 4 has a shorter inner skirt 24 radially inboard of the outer skirt 20, defining an annular channel 25 in which the top of the sidewall 5 can be received. The closure also has a hollow cylinder 26 depending downwardly from the centre of the top panel 19. The cylinder 26 is of a diameter to receive the piston 12, and is provided with thread formations 27 complementary to those thereon. An annular recess 28 in the base 11 allows the bottom of the cylinder 26 to be received therein.

The operation of the fitment 2 will now be generally described. The user grips the closure 4 and rotates it in a conventional manner. Initially, rather than unscrewing the closure from the housing 3, the rotation of the closure 4 urges the piston 12 downwardly, due to the action of the thread formations 16 and 27. When the downward force is sufficient, usually within 1 or 2 rotations of the closure, the fitment will snap to its second bistable position as shown in FIG. 4. In this position the arms 18 have reversed their position such that they extend not upwardly but downwardly, at a similar angle of approximately 30° to the plane of the removable panel 14. The sudden downward movement of the base 11, and especially the leg portions 15, causes the removable panel 14 to become fully separated from the remainder of the carton 1, fracturing cleanly around the pre-scored track 13.

Now that the arms 18 have inverted their position, further rotation of the closure 4 will cause the frangible bridges 22 between the outer skirt 20 and the tamper-evident band 21 to break, separating the band from the closure 4. Yet further unscrewing of the closure 4 allows it to be removed from the housing 3 to allow the contents of the carton to be dispensed as required.

The base 11, with the removable panel 14 still attached thereto, remain in the position shown in FIG. 4 whilst the product is being dispensed from the carton, the product flowing into the gaps 29 created between the base and the rest of the housing. Unlike many prior art dispensing arrangements, the removable panel remains attached to the fitment 2 and acts as a flow regulator to improve the flow of product from the carton. Product can be dispensed quickly from the carton with less of the “glugging” typically associated with many prior art carton fitments.

It will be appreciated by those skilled in the art that many features of the fitment, such as the shape of the base 11, the number and shape of the legs 15 or arms 18 can be varied without departing from the scope of the present invention. Similarly, although using the closure 4 to actuate the movement of the bistable central section 10 is most convenient, other ways may be employed to achieve the same effect as the design described above. Also, the fitment may be deployed with containers other than paperboard cartons, such as plastics containers or foil plastics laminates.

Referring now to FIGS. 5,6A and 6B there is shown an alternative embodiment of the same general construction and method of action as the embodiment shown in FIGS. 1 to 4.

The exterior of the cylinder 126 of the closure 104 is provided with cam surfaces 127 which co-operate with complimentary surfaces 116 arranged on the interior of the piston 112 of the housing 103. When the closure 104 is unscrewed it thrusts the piston 112 axially downwardly. It will be noted that the cylinder 126 is received in the piston 112 in this embodiment.

The interior surface of the lower end of the skirt 120 has a plurality of ratchet teeth 140 which engage corresponding teeth 145 on the sidewall 105 to prevent incorrect rotation of the closure. The teeth 140 are provided on a tamper evident band 121 which is frangibly attached to the lower end of the skirt 120. The ratchet mechanism effects breaking of the band from the closure as it is rotated.

The skirt 120 of the closure 104 and the sidewall 105 of the housing 103 have complementary counter screw threads 160, 165 which raise the closure as it is turned. However, approximately one half of a turn of the closure is sufficient to activate the opening mechanism so that the upward movement of the closure does not prevent the camming action.

In this embodiment the base 111 is provided with a plurality of piercing projections 135, in this case six, to help separate the panel (not shown) from the remainder of the container by concentrating the load.

The legs 118 include a thinned section 150 approximately half way along their length which allows the legs to hinge as the piston moves down. This prevents initial flexing movement of the legs prior to snapping downwards. The result is to reduce the piercing force but, in combination with the piercing projections 135, to provide an improved piercing action.

1. A fitment 2 for use with a container 1 having an operable section 14 adapted to be activated to allow access to the contents of the container, the fitment comprising:
i) a plastics housing 3 adapted to be secured to the container surrounding the operable section 14; and
ii) a panel portion 10 adapted to be secured to the operable section of the container, the panel portion 10 being attached to the housing 3 such that it is movable between first and second bistable positions, the panel portion 10 being operable by the user to cause it to move from its first position to its second position, this movement causing the operable section 14 of the container 1 to be separated from the remainder of the container 1 so as to provide an exit for the contents of the container, in its second position the panel portion 10 remaining attached to the housing 3.

2. A fitment 2 according to claim 1, characterised in that an additional component 4 is provided, the movement of the additional component 4 by the user causing the panel portion 10 to move from its first position to its second position.

3. A fitment 2 according to claim 2, characterised in that the additional component 4 is rotatable with respect to the housing 3, the rotation of the component 4 causing the movement of the panel portion 10.

4. A fitment 2 according to any of claims 1 to 3, characterised in that the fitment 2 is provided with a closure 4 adapted to seal the plastics housing 3.

5. A fitment 2 according to claims 3 and 4, characterised in that the closure 4 comprises the additional component, rotation of the closure 4 causing movement of the panel portion 10.

6. A fitment 2 according to claim 5, characterised in that the closure 4 includes a downwardly extending threaded member 26, and the panel portion 10 includes a complementary upwardly extending threaded member 12, the two threaded members 12, 26 corresponding such that rotation of the closure 4 is translated into a corresponding lateral movement of the panel portion 10.

7. A fitment 2 according to claim 6 characterised in that the downwardly extending member on the closure 4 comprises a cylinder 26 having a thread 27 on the internal surface thereof, and the upwardly extending member on the panel portion comprises a piston 12 having an external thread 16 thereon.

8. A fitment 102 according to claim 5, characterised in that the closure 104 includes a member 126 with a downwardly extending cam surface 127, and the panel portion 110 includes a member 112 with a complementary upwardly extending cam surface 116, the two cam surfaces 127, 116 corresponding such that rotation of the closure is translated into a corresponding lateral movement of the panel portion.

9. A fitment 2 according to any preceding claim, characterised in that the panel portion 10 is attached to the housing 3 by a plurality of arms 18, each arm 18 being disposed at an angle to the plane of the panel portion 10.

10. A fitment 2 according to claim 9, characterised in that the first bistable position of the panel portion 10 is when the arms 18 are disposed at a certain angle to the plane of the panel portion on one side thereof, and the second bistable position is when the arms 18 are disposed at the certain angle to the plane of the panel portion 10 on the opposite side thereof.

11. A fitment 2 according to any preceding claim, characterised in that the plastics housing 3 and the panel portion 10 are integrally moulded in one piece.

12. A fitment 2 according to any preceding claim, characterised in that the panel portion 10 is substantially in the form of a cone, with the base 11 of the cone being affixed to the operable section 14 of the carton.

13. A fitment 2 according to any preceding claim, characterised in that the panel portion 10 comprises a central section 10 surrounded by a plurality of legs 15 extending therefrom.

14. A fitment 2 according to any preceding claim, characterised in that the plastics housing 3 includes a substantially planar annular portion 6 adapted to be affixed to the container 1.

15. A fitment according to claim 14, characterised in that the planar annular portion 6 has a downwardly depending flange 9 on the inner radial extent thereof.

16. In combination, a container 1 and a plastics fitment 2, the container having an operable section 14 adapted to be activated to allow access to the contents of the container, the fitment 2 comprising:
i) a plastics housing 3 secured to the container 1 surrounding the operable section 14; and
ii) a panel portion 10 attached to the operable section 14 of the container, the panel portion 10 being attached to the housing 3 such that it is movable between first and second bistable positions, the panel portion 10 being operable by the user to cause it to move from its first position to its second position, this movement causing the operable section 14 to be separated from the remainder of the container so as to provide an exit through which the contents of the container may be dispensed, in its second position the panel portion 10 remaining attached to the housing 3 and the operable section 14 remaining attached to the panel portions.

17. The combination of claim 16, characterised in that the panel portion 10 comprises a central section 10 surrounded by a plurality of legs 15 extending therefrom, each leg 15 being disposed such that the distal end thereof is adjacent the edge of the operable section 14 of the container.
